(19) United States
(12) Patent Application Publication
(10) Pub. No.: US 2011/0272101 A1
(43) Pub. Date: Nov. 10, 2011

(54) MANUALLY OPERATED LABELER TETHERED TO AN ARTICULATING, WEIGHT BEARING BOOM AND LABEL SUPPLY

(76) Inventors: Enrique B. Schilling, Norfolk (GB); Gareth Melton, Norfolk (GB); Timothy Moore, Norwich Norfolk (GB); David Southwood, Norwich Norfolk (GB)

(21) Appl. No.: 12/736,578

(22) PCT Filed: Jul. 23, 2010
(86) PCT No.: PCT/US2010/002088

§ 371 Date: Jul. 26, 2011

Related U.S. Application Data
(60) Provisional application No. 61/274,536, filed on Aug. 18, 2009.

(51) Int. Cl. B65C 9/42; B32B 41/00; B32B 37/02

(52) U.S. Cl. 156/363; 156/538; 156/378

(57) ABSTRACT

A handheld label applicator for applying labels to single produce items is provided. The weight of the label applicator is adjustably suspended from an articulating boom to reduce fatigue of the user. A large supply of labels is positioned remotely from the applicator. Labels are moved from the label supply along a pathway adjacent the articulating boom to the handheld label applicator. The labels are registered with the label applicator actuation mechanism if they become out of registration. Nearly twice the speed of prior handheld labelers is achieved at a fraction of the cost of an automatic labeling machine.

### CROSS-REFERENCE TO RELATED APPLICATION

This application claims the benefit of and priority from U.S. provisional application Ser. No. 61/274,536 filed Aug. 18, 2009.

### BACKGROUND AND BRIEF SUMMARY

The present invention pertains generally to handheld manually operated labeling machines. More particularly, the invention provides an ergonomic, manually operated labeling machine for produce items that allows higher labeling speeds and eliminates problems with prior art labeling machines.

Prior art manual labeling machines are typically heavy and require repetitive motion by the user. The speed of labeling is inherently limited by the weight of the labeling machine, in that the user can only move the heavy machine from item to item at a limited speed. The labeling of produce items requires that the user label each individual produce item. Many thousands of labels are applied by a single user during a normal work day. The typical prior art labeling machine can only carry relatively small reels of labels requiring frequent reload operations causing unwanted downtime; and is relatively heavy, compared to the label applicator of this invention. In addition to a limited labeling speed and repetitive motion injuries suffered by the user, the machines are often dropped and damaged. The damaged machine can delay the labeling process, causing expensive “downgrading” of the produce items waiting to be labeled. Fines also may be levied against owners of the produce for substandard labeling by damaged label applicators.

What is needed in this art is a handheld manually operated labeling machine that allows faster labeling speeds, reduces injury and fatigue to the user, and which also minimizes damaged machines and “down time” caused by dropped labeling machines.

The present invention eliminates the above described problems. For the first time, the present invention provides a manually actuated label applicator that is tethered to, and suspended from, an articulating boom. The boom supports the weight of the labeler while allowing the label applicator to be easily and quickly moved through an adequate range of motion. Repetitive motion injuries and fatigue are either reduced significantly or eliminated. In addition, the articulating boom is connected to a support structure housing a large label roll. Since the label roll is not carried by the user, larger rolls with more labels can be used. The labels are transported across the boom to the label applicator. The result is an extremely lightweight label applicator (since the weight of the labeler is carried by the boom) which can achieve much higher labeling speeds than prior art manual labeling machines with reduced fatigue and repetitive motion injuries suffered by the user. By using larger label rolls, the present invention reduces the down time required to change label rolls in prior art hand labelers.

Articulating tool supports are known in the prior art as shown by U.S. Pat. Nos. 3,917,200; 6,711,972; 7,055,789 and 7,325,777. Counterbalancing mechanisms are also known as shown by U.S. Pat. No. 4,166,602, which teaches such a mechanism for supporting an X-ray tubehead.

None of the above referenced prior art deals with produce labeling machines. Furthermore, and perhaps/more importantly, the above prior art does not teach the feeding of working material to the supported tool along the pathway of the articulating support mechanism.

In contrast to the prior art noted above, the present invention provides, for the first time, an articulating support for a handheld manually operated produce labeling machine. Furthermore, the present invention provides a feed mechanism for labels wherein the labels are fed to the supported tool along the pathway of the articulating support! By continuously feeding the labels to the hand tool along the articulating support, the mass of the labeling applicator is kept to a minimum. Minimizing the mass of the label applicator while simultaneously supporting the weight of the applicator by the present invention has effectively nearly doubled the output of prior art hand manual labeling machines. The present invention allows a user to apply about 180 labels per minute, compared to about 90-100 labels per minute with prior art hand labelers.

Another significant aspect of the present invention is that it is a cost effective improvement to manual label applicators. The present invention nearly doubles the output of conventional hand labelers at a cost less than one-fourth of an automatic labeling machine and at a just a slightly greater cost than a conventional hand labeler!

A primary object of the invention is to provide a cost effective, high speed hand labeling machine for applying labels to individual items of produce.

A further object is to provide a hand operated or manual produce labeling machine that achieves reduced fatigue and injury to the operator and virtual elimination of instances of dropping of the labeling machine.

A further object is to provide a simple mechanism for achieving roughly twice the labeling speed of prior art hand or manual produce labeling machines.

Further objects and advantages will be apparent from the following description and drawings wherein:

### BRIEF DESCRIPTION OF THE DRAWINGS

FIG. 1 is a perspective view of a first embodiment of the invention;

FIG. 2 is a schematic, cross-sectional view of the label applicator including the label registration or alignment mechanism;

FIGS. 3-5 illustrate various mountings of the label supply roll relative to the articulating support for the label applicator;

FIG. 3 shows the label supply roll mounted adjacent the base of the articulating support;

FIG. 4 shows the label supply roll positioned below the articulating support mechanism;

FIG. 5 shows an alternate support for the articulating arm, with the label supply roll mounted below the articulating arm;

FIG. 6 shows an adjustable mechanism for varying the weight of the label applicator; and

FIG. 7 illustrates the guide mechanism for transporting labels from the label supply roll to the label applicator.

### DETAILED DESCRIPTION OF THE DRAWINGS

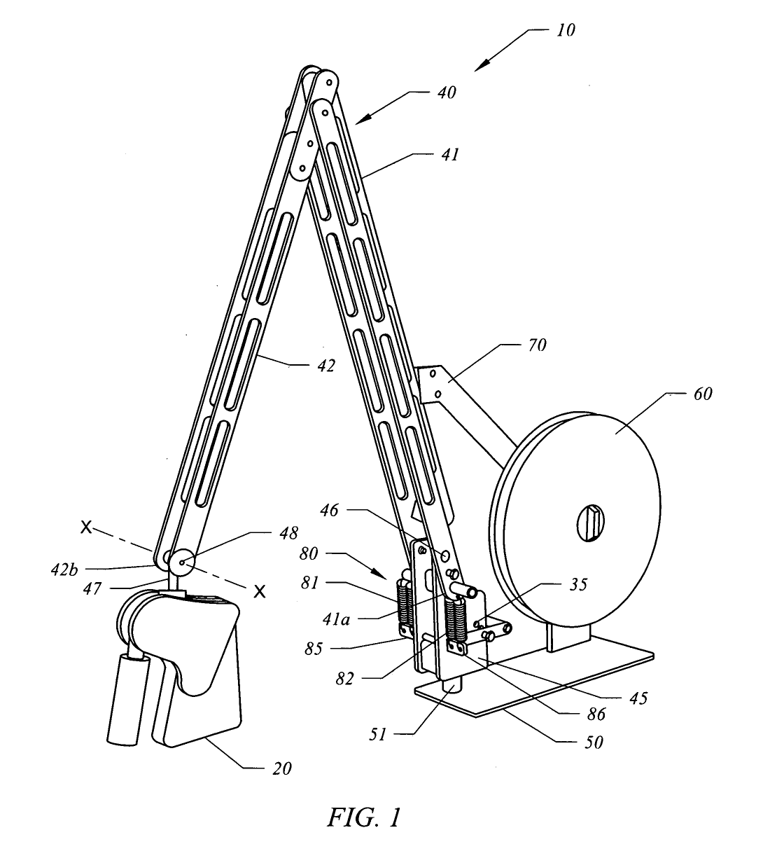

FIG. 1 illustrates one embodiment of the invention. The hand labeling system is shown generally as 10. The hand operated handheld label applicator 20 is tethered to and supported by articulating boom 40 by suspension arm 47. Boom 40 has a primary arm 41 and a secondary arm 42. Suspension arm 47 transfers the weight of applicator 20 to secondary arm 42 of boom 40. Suspension arm 47 allows applicator 20 to pivot around a generally horizontal axis X-X extending through support pin 48 carried by the tip 42b of secondary arm 42. Suspension arm 47 may have alternate configurations which allow sufficient freedom of motion for label applicator 20 to apply labels to produce items. The base 45 of boom 40 is carried by a pin 51 mounted on support 50. Base 45 carries primary arm 41 by a pin 46, allowing primary arm 41 to rotate about pin 46. Boom 40 is connected to support 50 by a vertical pin 51 mounted on support 50 to allow boom 40 to rotate about the vertical axis of pin 51 and the horizontal axis of pin 46 so that boom 40 is fully articulated.

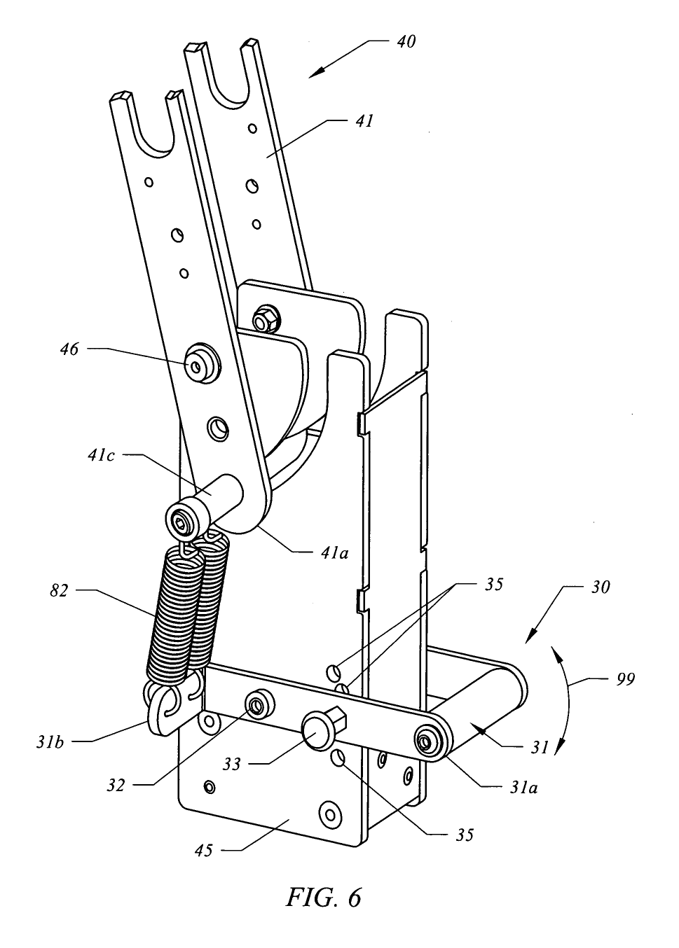

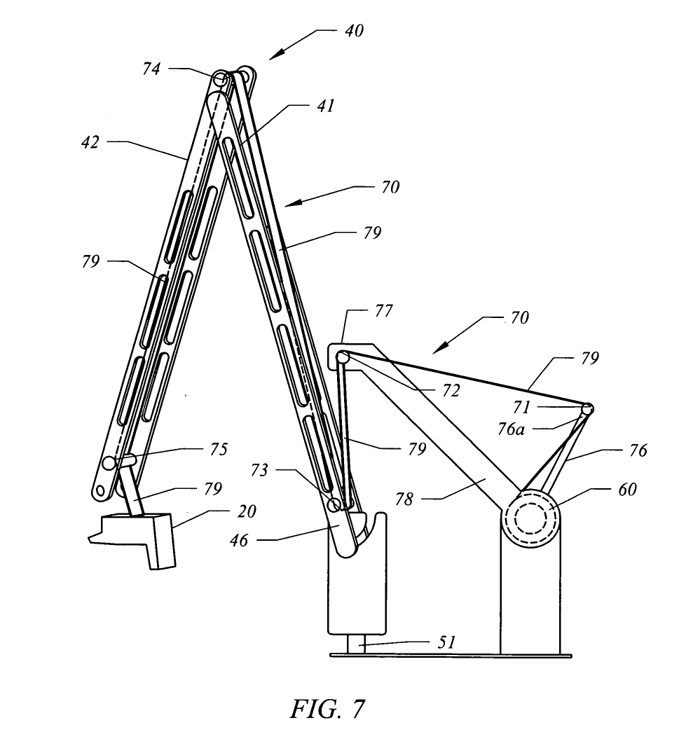

A suspension means 80 is connected to articulating boom 40 from base 45 for carrying at least a portion of the weight of handheld label applicator 20. In the embodiment shown in FIG. 1, the suspension means 80 comprises springs 81, 82 extending from brackets 85, 86 mounted on base 45 to the lower end 41a of primary arm 41. Suspension means 80 could alternately comprise a hydraulic or pneumatic cylinder. Suspension means 80 is adjustable as described below in conjunction with FIG. 6.

A relatively large label roll 60 is a label supply means and is carried by support 50 in the embodiment shown in FIG. 1. Label supply means, i.e. roll 60, is mounted remotely from label applicator 20 to reduce the weight of applicator 20. A label transport 70 (described below in detail with FIG. 8 and partially shown in FIG. 1 for clarity) continuously moves the label strip (not shown in FIG. 1 for clarity) from label roll 60, along boom 40 and suspension arm 47 to label applicator 20. Support 50 also carries a DC power supply (not shown for clarity). DC power is fed to label applicator 20 along boom 40.

Tape waste is rewound in the label applicator 20 as described below and disposed of by the operator. Alternately, tape waste could be transported back to the base station for continuous waste disposal with no operator intervention.

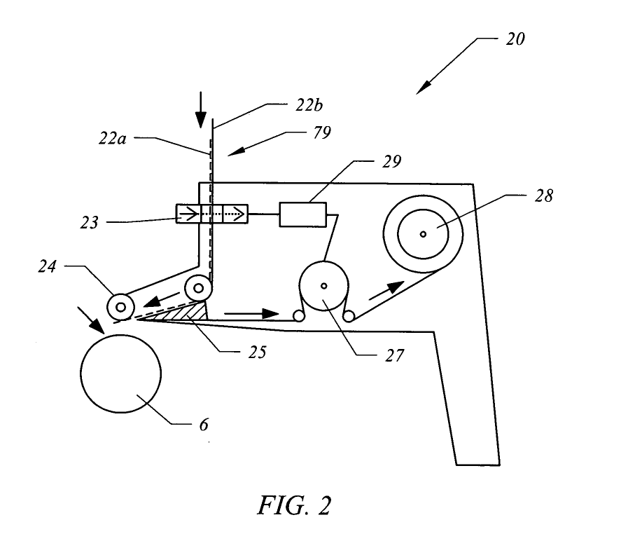

FIG. 2 is a schematic representation of label applicator 20.

Labels 22a are manually applied by the operator on their target 6, typically fruit in boxes. The label applicator 20 automatically dispenses one label of the roll or reel for each labeling action or actuation of the applicator 20. Each labeling sequence is triggered automatically by pressure detection on the transfer roller 24, as is known in the labeling art.

Incoming labels 22a are positioned on a backing tape 22b conforming a “web” or strip of labels 79. This web or strip is driven by a motorized sprocket wheel 27. As the web is driven forward, the labels 22a are stripped from their backing tape 22b through the stripper plate 25 and transferred to the target 6 with the aid of the transfer roller 24 during the application action of the operator which actuates the label applicator 20. The backing tape 22b waste is then rewound on the rewind reel 28.

The sprocket wheel 27 is driven by a position drive or drive controller 29 that accurately advances the tape 22b the exact length of a whole label pitch on each labeling sequence by rotating sprocket 27.

This method alone can position several tens of labels in an “open loop” fashion; however, due to system's tolerances and drag, the label starts losing position.

To overcome this problem, the label applicator 20 utilizes a novel method of synchronization or registration for accurately positioning or registering labels on the transfer roller; an optical label sensor 23 is used to detect the edge of the labels and feedback position to the sprocket wheel 27 position drive through drive controller 29. Drive controller 29 is connected to and responsive to optical label sensor 23. If the labels are not properly registered or aligned with the actuation mechanism of the applicator, drive control 29 causes sprocket 27 to advance until the labels are aligned or registered. In this manner a label registration means is formed comprising optical label sensor 23, drive controller 29 and sprocket 27 for repositioning the label strip in applicator 20 by advancing the strip until the labels are aligned with the actuation mechanism of applicator 20.

The label sensor 23 utilizes an optical principle; it “sees through” the incoming labels' web and detects variations in transparency between the backing tape alone 22b and the backing tape with a label 22a to determine the edge position of a label.

The sensor is capable of “self calibrating” to different environmental conditions, e.g.: variations in tape and label thickness and transparency, dirt, ambient light, etc. As part of the detection process, the sensor can dynamically calibrate a) its transmitting power, b) its receiver sensitivity and c) the detection threshold.

Because label position is kept for a relatively large amount of labels by the sprocket wheel 27, the sensor has enough time to dynamically adapt to changing environmental conditions; as labels are applied the sensor can produce one valid edge detection signal after several labels (for example: one valid position signal every ten labels).

Upon valid edge detection from the sensor 23, the drive controller 29 of the sprocket wheel 27 compensates position accordingly and the cycle starts over again.

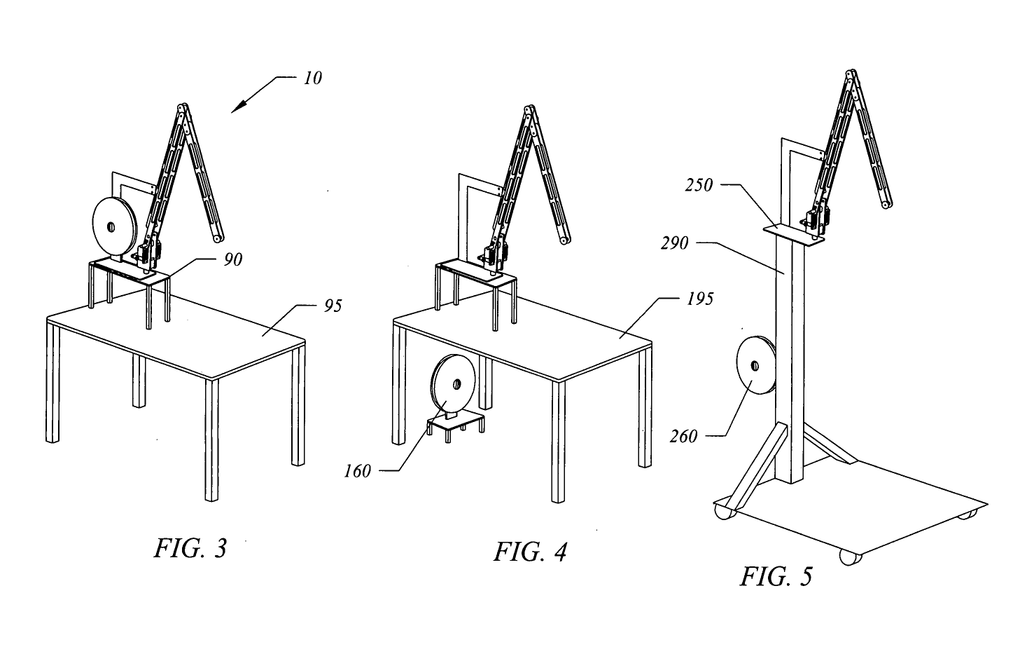

FIGS. 3-5 are schematic representations of alternate forms of the invention.

FIG. 3 illustrates an embodiment wherein the hand labeling system 10 as shown in FIG. 1 is mounted on a pedestal 90 which in turn is mounted on table 95. Boxes of produce are placed on table 95 for labeling.

FIG. 4 illustrates an embodiment similar to that shown in FIG. 3, but wherein label roll 160 is mounted remotely from label applicator (not shown) and below table 195 to increase the distance of label roll 160 from the working area on top of table 195 in which labels are applied.

FIG. 5 illustrates a further embodiment in which the boom support 250 is mounted on top of mast 290. Label roll 260 is positioned remotely from label applicator (not shown) and near the base of mast 290.

FIG. 6 illustrates the adjustment means 30 by which the user can easily and readily adjust the percentage of the weight of the label applicator 20 carried by the articulating boom 40. FIG. 6 shows one side of adjustment means 30; a spring 81 (FIG. 1) is not visible in FIG. 6.

A movable lever or handle 31 is pivotally mounted by pin 32 to base 45 of boom 40. The proximal end 31a of lever or handle 31 is easily grasped by the user and moved upwardly or downwardly as shown by arrow 99. The distal end 31b of handle 31 carries spring 82 which is connected to the proximal end 41a of primary arm 41 by pin 41c. As the proximal end 31a of handle 31 is raised, spring 82 is extended, carrying more of the weight of applicator 20. Conversely, if lever or handle 31 is lowered, the spring 82 is shortened, and less of the weight of applicator 20 is carried by spring 82. A retaining knob 33 is carried by handle 31. Knob 33 carries a spring loaded pin (not visible in FIG. 6) which engages one of a plurality of retaining holes 35 formed in base 45. The user can easily adjust the amount of weight of the label applicator carried by the boom 40 through a range of 0% to 100% of the weight of the applicator.

FIG. 7 illustrates schematically the label transport means 70 used to continuously move label strip 79 from the label supply means or roll 60 to the handheld label applicator 20 along a pathway adjacent boom 40 as described herein. A plurality of rollers 71-75 is positioned along or adjacent the pathway of primary and secondary arms 41, 42 of boom 40. A tape tension arm 76 extends upwardly from roll 60 and carries a roller 71 and its upper end 76a. Tape tension arm 76 provides a “soft start” for the drive sprocket 27 (FIG. 2) which pulls the label strip 79 across rollers 71-75. Rollers 71 and 72 are positioned above supply roll 70 as shown in FIG. 7. Roller 72 is mounted at the tip 77 of support arm 78. Support arm 78 extends upwardly from label supply 60. Roller 73 is positioned above the pivot point 46 of primary arm 41. Roller 74 is positioned at the intersection of primary arm 41 with secondary arm 42. Roller 75 is positioned near the tip or distal end 42b of secondary arm 42. This positioning of the rollers allows the label strip 79 to continuously follow a path adjacent boom arms 41 and 42 as those arms articulate as the operator moves the label applicator. As primary arm 41 rotates relative to vertical pin 51, the label strip twists as roller 73 rotates around a vertical axis relative to stationary roller 72. The distance between rollers 72 and 73 allows the twisting of the label strip 79 between those two rollers. The side walls of boom arms 41 and 42 protect the label strip 79 as it moves from roll 60 to label applicator 20.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated.

What is claimed is:

1. A manually operated labeling machine for applying labels to produce items, comprising,
a handheld label applicator
an articulating boom connected to and supporting said label applicator
suspension means connected to said articulating boom for carrying at least a portion of the weight of said label applicator,
label supply means for continuously feeding labels to said label applicator, wherein said label supply means includes a roll of labels carried on a label strip, wherein said label supply means is mounted remotely from said label applicator, and
label transport means for continuously moving said label strip from said label supply means to said handheld label applicator along a pathway adjacent said articulating boom.

2. The labeling machine of claim 1 wherein said suspension means is a spring connected to said articulating boom.

3. The labeling machine of claim 2 further comprising adjustment means including a lever for adjusting the tension in said spring.

4. The labeling machine of claim 3 wherein said suspension means is adjustable to carry from 0% to 100% of the weight of said label applicator.

5. The labeling machine of claim 1 wherein said label transport means includes a plurality of rollers carried by said articulating boom for moving and guiding said label strip to said label applicator.

6. The labeling machine of claim 5 wherein said label applicator includes a drive sprocket for pulling said label strip from said label supply means and across said rollers to said label applicator.

7. The machine of claim 6 further comprising an optical label sensor in said label applicator for sensing the position of labels by detecting variations in transparency between said label strip alone and said label strip carrying a label.

8. The machine of claim 7 further comprising a label registration means responsive to said label sensor means for sensing when labels are not registered and for advancing said label strip in said applicator in response to input from said optical label sensor until said labels are in registration with the applicator actuating mechanism.

9. The labeling machine of claim 1 wherein said articulating boom comprises a primary arm and a secondary arm, wherein said primary arm is carried by a base mounted on a vertically extending first pin and said base and primary arm are free to rotate about said first pin, wherein said primary arm is also carried by a horizontally mounted pin carried by said base, and said secondary arm is carried by, and is free to rotate around a second, horizontal pin mounted in said primary arm.

10. The labeling machine of claim 9 wherein said label applicator is suspended from said secondary arm by a horizontally extending pin, whereby said applicator is free to rotate relative to said pin.

11. The labeling machine of claim 9 wherein said suspension means is a spring extending from said base to said primary arm of said boom.

12. The labeling machine of claim 11 wherein said suspension means is adjustable by movement of a lever which extends or shortens said spring.
